(19) United States
(12) Patent Application Publication
(10) Pub. No.: US 2007/0088473 A1
(43) Pub. Date: Apr. 19, 2007

(54) Method of communications between telematics terminal and electronic control unit and vehicle sensor information management method and apparatus using the same

(75) Inventors: Young Bag Moon, Daejeon-city (KR); Min Jung Kim, Daejeon-city (KR); Yeon Jun Choi, Daejeon-city (KR); Sun Joong Kim, Daejeon-city (KR); Oh Cheon Kwon, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/320,203

(22) Filed: Dec. 28, 2005

(30) Foreign Application Priority Data
Oct. 14, 2005 (KR) 10-2005-0096951

(51) Int. Cl. G06F 17/00

(52) U.S. Cl. 701/36; 701/1

(57) ABSTRACT

A technology for processing vehicle sensor information is provided. The technology relates to a communication method which is performed between a telematics terminal and an electronic control unit, and a vehicle sensor information management method and apparatus. Sensor information is processed in a number of vehicle electronic control units, and then the processed sensor information is transferred to a telematics terminal via a communication gateway. The transferred sensor information is managed by a software module in the telematics terminal. A communication method of processing vehicle sensor information and a software module for receiving and processing sensor information between ECUs (Electronic Control Units) and a telematics terminal. The communication method for processing sensor information performs CAN communication between a communication gateway and the vehicle ECUs and serial communication between the communication gateway and the telematics terminal. The telematics terminal receives processed sensor information from the vehicle electronic control units via the communication gateway. Here, the processed sensor information is transmitted from the communication gateway to the telematics terminal using serial communication, without the need for a separate CAN communication module. The software module processing sensor information in the telematics terminal is in charge of processing and managing the received sensor information. Fault information and performance information are kinds of sensor information. ECUs which process sensor information in a vehicle can be connected with a telematics terminal via a communication gateway which employs CAN communication and serial communication, without adopting a separate communication module. Accordingly, changes in status of a vehicle with respect to fault or performance of the vehicle can be systematically managed via management of a current status and a history status of vehicle sensor information.

### CROSS-REFERENCE TO RELATED PATENT APPLICATION

This application claims the benefit of Korean Patent Application No. 10-2005-0096951, filed on Oct. 14, 2005, in the Korean Intellectual Property Office, the disclosure of which is incorporated herein in its entirety by reference.

### BACKGROUND OF THE INVENTION

1. Field of the Invention

The present invention relates to a communication method which is performed between a telematics terminal and an electronic control unit (ECU), and a vehicle sensor information management method and apparatus. More particularly, the present invention relates to a method of communicating between a telematics terminal and an ECU, and a method of and apparatus for managing vehicle sensor information which is processed in the ECU and transferred to the telematics terminal via a communication gateway, using the method of communicating between the telematics terminal and the ECU.

2. Description of the Related Art

The word “Telematics” is a compound word made by joining the words “Telecommunication” and “Information.” Telematics technology is defined as a service technology providing various kinds of information or functions such as traffic guide information, emergency rescue, remote vehicle diagnosis, internet financing, internet news, internet e-mail, internet messenger, internet video-on-demand (VOD), and mobile office functions, for vehicles or drivers via a terminal installed in a vehicle, using global positioning system (GPS) technology and a bidirectional mobile communications network. In the telematics technology, sensors in an apparatus generate performance information on the performance of the apparatus and the performance information is used for emergency rescue, remote vehicle diagnosis, etc. A variety of electronic devices are updated and modernized, and thus a variety of sensor devices are increasingly used in order to offer convenience to users. However, management of information from such sensors has not been adequately addressed.

A self-diagnosis system for a vehicle using a telematics device disclosed in Korean Laid-open Patent Publication No. 2004-0011228 on 5 Feb. 2004 defines a system which requests self-diagnosis information from an electronic control unit (ECU) and confirms the self-diagnosis information in real-time in the telematics device, but does not teach a method of receiving and processing vehicle sensor information as in the present invention.

A method of transferring vehicle fault information using a CAN (Control Area Network) communication method disclosed in Korean Laid-open Patent Publication No. 2005-0071159 on 7 Jul. 2005 discloses a technology of transferring vehicle fault information to an ECU using CAN communication, but does not teach a method of receiving and processing vehicle sensor information as in the present invention.

A signal measurement device using a sensor and a communication network disclosed in Korean Laid-open Patent Publication No. 2005-0061036 on 22 Jun. 2005 discloses a technology for receiving sensor input signals using a TCN (Train Communication Network) and confirming the state of electronic devices, but does not disclose a CAN to serial communication method as in the present invention.

### SUMMARY OF THE INVENTION

To solve the above problems of the conventional art, it is an object of the present invention to provide a communication method which is performed between a telematics terminal and an electronic control unit (ECU) via a communication gateway.

It is another object of the present invention to provide a method and apparatus for processing vehicle sensor information in a telematics terminal using the communication method which is performed between the telematics terminal and an electronic control unit (ECU).

To accomplish the above object of the present invention, there is provided a communication method which is performed between a telematics terminal and an electronic control unit (ECU) in order to process vehicle sensor information, the communication method comprising: installing a communication gateway between a plurality of ECUs (electronic control units) which manage vehicle sensors and a telematics terminal which systematically manages a change in the state indicating whether or not a vehicle is out of order based on fault information and performance information of the vehicle from each ECU, wherein a plurality of the ECUs and the communication gateway are connected with each other via CAN (Control Area Network) communication, and the communication gateway and the telematics terminal are connected with each other via serial communication.

To accomplish another object of the present invention, there is also provided a vehicle sensor information management method comprising: installing a communication gateway between a plurality of ECUs (electronic control units) which manage vehicle sensors and a telematics terminal which systematically manages a change in the state indicating whether or not a vehicle is out of order based on fault information and performance information of the vehicle from each ECU; connecting a plurality of the ECUs and the communication gateway with each other via CAN (Control Area Network) communication, and connecting the communication gateway and the telematics terminal with each other via serial communication; gathering performance information generated from the vehicle sensors, and transferring fault information to the telematics terminal if the performance information meets a predetermined fault code condition, in the ECUs, and then establishing a fault class based on the fault information and storing the fault class in a fault history table in the telematics terminal; and transferring a performance information inquiry message to the ECUs in order to manage performance information in the telematics terminal and transferring performance information of a corresponding sensor to the telematics terminal in the ECUs which receive the performance information inquiry message, to then store the received performance information in a performance history table.

Preferably, the sensor information is transferred to a communication manager in the telematics terminal via the communication gateway by serial communication, the sensor information transferred to a communication manager is transferred to an information manager handling information management, and then functions such as history management, inquiry, and report of the sensor information are processed in the information manager, wherein the information manager is connected with a TSP (Telematics Service Provider) center manager to thereby provide a service such as remote vehicle diagnosis or emergency rescue.

To accomplish still another object of the present invention, there is still also provided a vehicle sensor information management apparatus comprising:

a plurality of ECUs (electronic control units) which manage vehicle sensors;

a telematics terminal which systematically manages a change in the state indicating whether or not a vehicle is out of order based on fault information and performance information of the vehicle from each ECU; and

a communication gateway which is installed between the plurality of the ECUs and the telematics terminal and which is connected with the plurality of the ECUs via CAN (Control Area Network) communication and connected with the telematics terminal via serial communication,

wherein when performance information is generated from the vehicle sensors, and gathered by the ECUs is transferred to the telematics terminal, fault information is transferred to the telematics terminal if the performance information meets a predetermined fault code condition, in the ECUs, and then a fault class is established based on the fault information and the fault class is stored in a fault history table in the telematics terminal, and wherein

a performance information inquiry message is transferred to the ECUs in order to manage performance information in the telematics terminal and performance information of a corresponding sensor is transferred to the telematics terminal in the ECUs which receive the performance information inquiry message, to then store the received performance information in a performance history table.

Preferably, the telematics terminal comprises: a communication manager which receives the sensor information via the communication gateway by serial communication; an information manager which performs information management using the sensor information transferred from the communication manager and then processes functions such as history management, inquiry, and report of the sensor information; and a TSP (Telematics Service Provider) center manager which is connected with the information manager to thereby provide a service such as remote vehicle diagnosis or emergency rescue.

Preferably, the communication manager, the information manager, and the TSP (Telematics Service Provider) center manager which are installed in the telematics terminal are configured into a software module, respectively, in order to process received sensor information.

### BRIEF DESCRIPTION OF THE DRAWINGS

The above and other objects and advantages of the present invention will become more apparent by describing the preferred embodiment thereof in more detail with reference to the accompanying drawings in which:

FIG. 1 is a diagram for explaining a procedure where fault information and performance information is transferred from a vehicle sensor to a telematics terminal and then managed according to the present invention;

FIG. 2 is a block diagram for explaining a communication system structure where information is transferred from vehicle sensors to a telematics terminal;

FIG. 3 is a block diagram for explaining a relationship between a communication gateway and a telematics terminal including a communication manager, an information manager, and a TSP (Telematics Service Provider) center manager according to the present invention;

FIG. 4 is a block diagram for explaining a structure for processing fault information in the information manager of the telematics terminal of FIG. 3; and

FIG. 5 is a block diagram for explaining a structure for processing performance information in the information manager of the telematics terminal of FIG. 3.

### DETAILED DESCRIPTION OF THE INVENTION

A method of communicating between a telematics terminal and an electronic control unit (ECU), and a vehicle sensor information management method and apparatus according to a preferred embodiment of the present invention will be described with reference to the accompanying drawings.

FIG. 1 is a diagram for explaining a procedure where fault information and performance information is transferred from a vehicle sensor 100 to a telematics terminal 120 and then managed according to the present invention. Referring to FIG. 1, the performance information generated by the vehicle sensor 100 is received by the ECU 120. An electronic control unit (ECU) 110 transfers fault information to a telematics terminal 120 if performance information meets a predetermined fault information code condition, and the telematics terminal 120 receives the fault information and sets a fault class and stores the fault information and fault class in a fault history table. The telematics terminal 120 sends a performance information inquiry message to the ECU 110 to manage performance information, and the ECU 110 having received the information inquiry message transfers performance information of a corresponding sensor (such as the vehicle sensor 100) to the telematics terminal 120. The transferred performance information is stored in the performance history table.

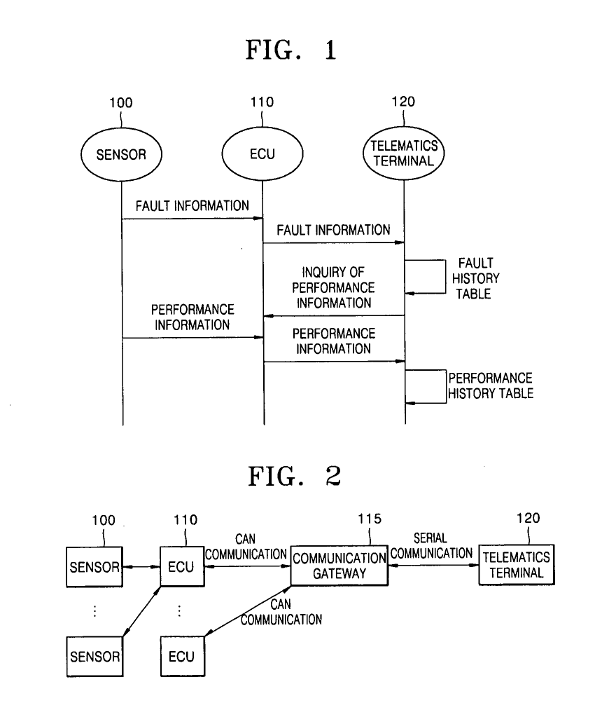

FIG. 2 is a block diagram for explaining a communication system structure where information is transferred from a plurality of vehicle sensors 100 to a telematics terminal 120. Referring to FIG. 2, each vehicle sensor 100 is managed by a corresponding ECU 110. The ECUs 110 are connected with a communication gateway 115 via CAN (Control Area Network) communication. The communication gateway 115 is connected with the telematics terminal 120 via serial communication.

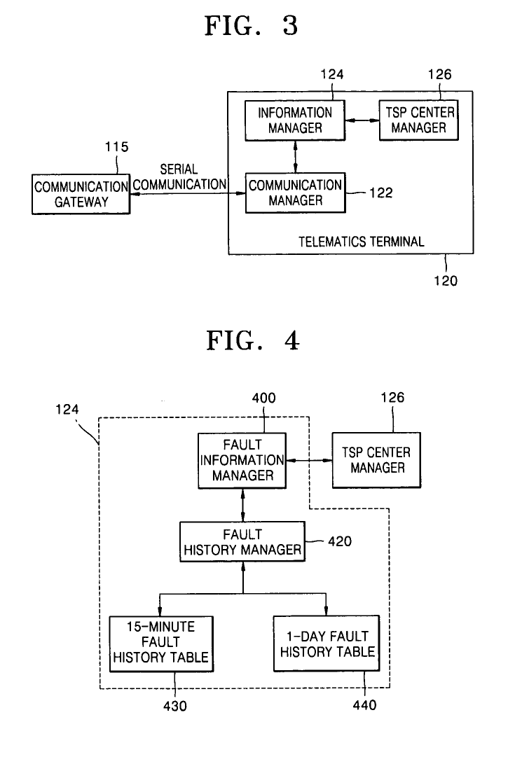

FIG. 3 is a block diagram for explaining a relationship between a communication gateway 115 and a telematics terminal 120 including a communication manager 122, an information manager 124, and a TSP (Telematics Service Provider) center manager 126. Referring to FIG. 3, the communication gateway 115 communicates with the communication manager 122 in the telematics terminal 120 via serial communication. The communication manager 122 sends the received sensor information to the information manager 124 which handles information management. The information manager 124 handles management of sensor information history, inquiries of sensor information and reporting of sensor information, and is connected with the TSP (Telematics Service Provider) center manager 126 to provide services such as remote vehicle diagnosis and emergency rescue.

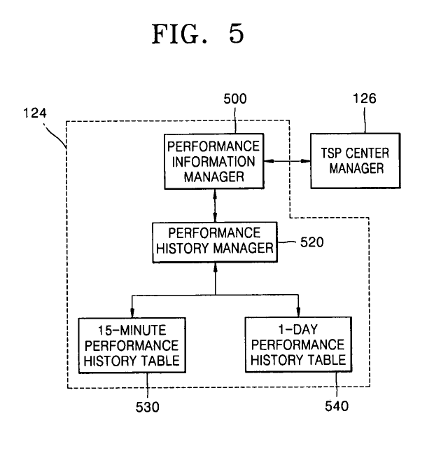

Here, the information manager 124 of FIG. 3 may be implemented into a structure for processing fault information as shown in FIG. 4, and/or a structure for processing performance information as shown in FIG. 5.

FIG. 4 is a block diagram for explaining a structure for processing fault information in the information manager 124 of the telematics terminal 120 of FIG. 3. Referring to FIG. 4, a fault information manager 400 in the information manager 124 establishes a fault class with respect to the received fault information. The established fault class is stored in a 15-minute fault history table 430 and a 1-day fault history table 440 by a fault history manager 420. For example, the fault history manager 420 stores a 15-minute fault class in the 15-minute fault history table 430 and stores a 1-day fault class in the 1-day fault history table 440. The fault information manager 400 is connected with the TSP (Telematics Service Provider) center manager 126, to thereby provide functions of inquiring and reporting a current status and a historical status of fault information.

FIG. 5 is a block diagram for explaining a structure for processing performance information in the information manager 124 of the telematics terminal 120 of FIG. 3. Referring to FIG. 5, a performance information manager 500 in the information manager 124 receives and processes the performance information, and the performance information manager 500 stores and manages the processed performance information in a 15-minute performance history table 530 and a 1-day performance history table 540 using a performance history manager 520. For example, the performance history manager 520 stores a 15-minute performance class in the 15-minute performance history table 530 and stores a one-day performance class in the 1-day performance history table 540. The performance information manager 500 is connected with the TSP (Telematics Service Provider) center manager 126 to thereby provide functions of inquiring and reporting current and historical status of performance information.

As described above, the present invention can connect ECUs which process sensor information in a vehicle with a telematics terminal via a communication gateway which employs CAN communication and serial communication, without adopting a separate communication module. Accordingly, changes in status with respect to fault or performance of a vehicle can be systematically managed using management of a current status and a history status of vehicle sensor information.

As described above, the present invention has been described with respect to a particularly preferred embodiment. However, the present invention is not limited to the above embodiments, and it is possible for one who has ordinary skill in the art to make various modifications and variations, without departing off the spirit of the present invention.

What is claimed is:

1. A communication method which is performed between a telematics terminal and an electronic control unit (ECU) in order to process vehicle sensor information, the communication method comprising:
installing a communication gateway between a plurality of ECUs (electronic control units) which manage vehicle sensors and a telematics terminal which systematically manages changes in state of a vehicle indicating whether or not a vehicle is out of order based on fault information and performance information of the vehicle from each ECU,
wherein a plurality of the ECUs are connected to the communication gateway via Control Area Network (CAN) communication, and the communication gateway is connected to the telematics terminal via serial communication.

2. A vehicle sensor information management method comprising:
installing a communication gateway between a plurality of ECUs (electronic control units) which manage vehicle sensors and a telematics terminal which systematically manages changes in state of a vehicle indicating whether or not a vehicle is out of order based on fault information and performance information of the vehicle from each ECU;
connecting a plurality of the ECUs and the communication gateway with each other via Control Area Network (CAN) communication, and connecting the communication gateway and the telematics terminal with each other via serial communication;
receiving performance information generated by the vehicle sensors, and transferring fault information to the telematics terminal if the performance information meets a predetermined fault code condition in the ECUs, and then establishing a fault class based on the fault information and storing the fault class in a fault history table in the telematics terminal; and
transferring a performance information inquiry message from telematics terminal to the ECUs in order to manage performance information in the telematics terminal and transferring performance information of sensors in the ECUs which receive the performance information inquiry message, from the ECUs to the telematics terminal and then storing the received performance information in a performance history table.

3. The vehicle sensor information management method according to claim 2, wherein the sensor information is transferred to a communication manager in the telematics terminal via the communication gateway by serial communication, the sensor information transferred to the communication manager is transferred to an information manager which handles information management, and then functions such as history management of, inquiry about, and report about the sensor information are processed in the information manager, and the information manager is connected with a TSP (Telematics Service Provider) center manager to thereby provide a service such as remote vehicle diagnosis or emergency rescue.

4. A vehicle sensor information management apparatus comprising:
a plurality of ECUs (electronic control units) which manage vehicle sensors;
a telematics terminal which systematically manages changes in state of a vehicle indicating whether or not a vehicle is out of order based on fault information and performance information of the vehicle from each ECU; and
a communication gateway which is installed between the plurality of the ECUs and the telematics terminal and which is connected with the plurality of the ECUs via Control Area Network (CAN) communication and connected with the telematics terminal via serial communication,
wherein when performance information is generated by the vehicle sensors, received by the ECUs, and transferred to the telematics terminal, fault information is transferred to the telematics terminal if the performance information meets a predetermined fault code condition in the ECUs, and then a fault class is established based on the fault information and the fault class is stored in a fault history table in the telematics terminal, and
wherein a performance information inquiry message is transferred from the telematics terminal to the ECUs in order to manage performance information in the telematics terminal and performance information of sensors in the ECUs which receive the performance information inquiry message is transferred from the ECUs to the telematics terminal, and then the received performance information is stored in a performance history table.

5. The vehicle sensor information management apparatus according to claim 4, wherein the telematics terminal comprises: a communication manager which receives the sensor information via the communication gateway by serial communication; an information manager which performs information management using the sensor information transferred from the communication manager and then processes functions such as history management of, inquiry about, and report about the sensor information; and a TSP (Telematics Service Provider) center manager which is connected with the information manager and provides a service such as remote vehicle diagnosis or emergency rescue.

6. The vehicle sensor information management apparatus according to claim 5, wherein the communication manager, the information manager, and the TSP (Telematics Service Provider) center manager which are installed in the telematics terminal are configured into a software module, respectively, in order to process received sensor information.
